(19) United States
(12) Patent Application Publication
(10) Pub. No.: US 2008/0132265 A1
(43) Pub. Date: Jun. 5, 2008

(54) REDUCING CURRENT CONSUMPTION WITH RX DIVERSITY CIRCUIT

(75) Inventor: Bogdan TUDOSOIU, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/565,802

(22) Filed: Dec. 1, 2006

(51) Int. Cl. H04B 7/00

(52) U.S. Cl. 455/522

(57) ABSTRACT

A method, a mobile station, a base station and a computer program product operating in a wireless communication network is described, where an RX diversity circuit is only switched on if the current consumption caused by an increase in output power from the transmitter in order to meet a signal quality target in the receiver would lead to a higher current consumption than the switching on of an RX diversity circuit in the receiver.

### TECHNICAL FIELD

The present invention is related to the field of RX diversity circuits for wireless communication.

### BACKGROUND OF THE INVENTION

In today's world of ever growing need for more bandwidth and the ensuing increase in data rates in wireless communication networks, mobile stations are important consumers of such bandwidth. When designing a mobile station, however, design restrictions dictate that some parameters, such as current consumption, volume or other parameters have to be compromised because, at some point, they may conflict with the desire to use an increasing data rate for the mobile terminal.

Some developments on the wireless markets, such as WCDMA (Wide bandwidth Carrier Division Multiple-Access), HSPDA (High Speed Packet Data Access) and receiver diversity (RX diversity) have led to increased current consumption and thus, to use these developments, trade-offs relating to increased current consumption of the wireless device need to be made.

RX diversity is appreciated as being one important factor in cell planning and the ability of the network to increase its capacity. It is likely that RX diversity will be supported by most network operators in the near future. One may define RX diversity as a way of improving the quality of reception for a radio signal by receiving two versions of the same signal at two or more antennas. In this fashion the SNR (Signal-to-Noise Ratio) for the received signal is improved. Different diversity techniques exist, such as using only the signal with the highest SNR or RSSI (Received Signal Strength Indicator) received on one of the two or more antennas and by using a combined signal from both antennas in order to improve the SNR of the received signal.

However, the drawback of RX diversity is the increased current consumption in the device using it. Typically, current consumption in diversity mode at a mobile terminal will increase the current consumption in a mobile station by between 10-20% and therefore put a question mark on mass penetration of RX diversity in mobile stations.

Some known attempts at reducing power consumption in a mobile station due the introduction of RX diversity are described in the documents U.S. Published patent application No. 2004/0219959 and U.S. Published patent application No. 2005/0197080.

U.S. 2004/0219959 to Kayrallah et al. describes the switching of the additional receiver antenna at the mobile station in case the received signal strength falls below a desired value. Otherwise, the receiver at the mobile station operates in single receiver mode.

Additionally, U.S. 2005/0197080 to Ulupinar discloses receiver diversity in a mobile station where either the available power on the forward link is increased or a second antenna is switched on in order to make use of receiver diversity to reach a desired FER (Frame Error Rate) target.

While the receiver diversity switching disclosed in Kayrallah only takes place in the mobile station, the receiver diversity in Ulupinar among others takes into account the operating conditions in the wireless network, transmission requirements and control settings in order to make the decision whether to switch to receiver diversity or single antenna signal reception.

It would be desirable to improve upon existing receiver diversity schemes.

### SUMMARY OF THE INVENTION

In one aspect, a method of reducing power consumption in a base station in a wireless communication network is described that includes measuring a first value indicative of an error rate for a signal received at the base station; adjusting a signal quality target when the measured first value is determined to be outside a predefined range; measuring a second value indicative of a signal quality for the signal received at the base station and comparing the measured signal to the adjusted signal quality target; examining whether the second value has reached or exceeded a threshold value; opening a receiver diversity circuit in the base station when the second value reaches or exceeds the threshold value; measuring again the second value indicative of the signal quality for the signal received at the base station and comparing the second value to the signal quality target; and sending a signal to a mobile station instructing the mobile station to decrease output power used by the mobile station.

This method may tend to reduce current consumption in the base station, since the RX diversity circuit in the base station is only switched on when needed instead of being switched on constantly. On the other hand, the switching on of the diversity circuit also lowers the signal quality value needed to meet the set signal quality target above, and thus the reduction of the output power for the signal transmitted from a mobile station to the base station may lead to lower current consumption at the mobile station as well.

Additionally, the method may be performed at predefined time periods.

Additionally, the first value indicative of the error rate may be at least one of BLER (Block Error Rate), FER (Frame Error Rate), or BER (Bit Error Rate.

Additionally, the signal quality target and the second value indicative of the signal quality is at least one of SIR (Signal to Interference Ratio), SINR (Signal-to-Interference-and-Noise Ratio), or RSSI (Received Signal Strength Indicator).

Additionally, the threshold value for the signal quality of the signal received at the base station may comprise a value in which increased output power in the signal received at the base station leads to a greater power consumption in the mobile station than the power consumption in the base station due to opening the receiver diversity circuit in the base station.

Additionally, the output power for the signal received at the base station may be the power at which the signal was transmitted from one or more mobile stations in the wireless communication network.

According to another aspect, a method of reducing power consumption in a mobile station in a wireless communication network is disclosed. The method may comprise: measuring a first value indicative of an error rate for a signal received at the mobile station; adjusting a signal quality target in case the measured first value is determined to be outside of a predefined range; measuring a second value indicative of the signal quality for the signal received at the mobile station and comparing the measured signal to the adjusted signal quality target; examining whether the second value has achieved or exceeded a threshold value; opening a receiver diversity circuit in the mobile station when the second value achieves or exceeds the threshold value; measuring again the second value indicative of the signal quality for the signal received at the mobile station and comparing the second value to the signal quality target; and sending a signal to a base station instructing the base station to decrease output power used by the base station.

This method may tend to save battery power in a mobile station by only switching on the RX diversity circuit in the mobile station when needed. The switching on of the RX diversity circuit may also lead to a lowering of the value of the signal quality which is needed to meet the set signal quality target. As a consequence, the base station may lower its output power for the signal transmitted to the mobile station and hence reduce its current consumption.

Additionally, according to the method, the output power for the signal received at the base station is the power at which the signal was transmitted from one or more base stations in the wireless communication network.

In yet another aspect, a mobile station for communication in a wireless communication network is disclosed. The mobile station may comprise: a first unit for measuring a first value indicative of an error rate for a signal received at the base station and for measuring a second value indicative of a signal quality for the signal received at the base station; a second unit for comparing the measured first value with a predefined value indicative of the error rate for the signal and for comparing the second value with a threshold value indicative of the signal quality; a diversity receiver circuit; and a control unit for adjusting a signal quality target when the measured first value is determined to be outside a predefined value range, where the control unit is further configured to open the receiver diversity circuit when the threshold value indicative of the signal quality has been reached or exceeded, wherein the first unit is further configured to repeatedly measure the second value indicative of the signal quality for the signal received at the base station and where the second unit is further configured to repeatedly compare the second value indicative of the signal quality for the signal received at the base station with the target signal quality and wherein the control unit is configured to send a signal to a mobile station instructing the mobile station to decrease output power sent to the base station.

Additionally, the first unit may comprise a transceiver and the second unit a processing unit.

According to another aspect, a computer program product comprising instructions for execution by a processor is described. The executed instructions may measure a first value indicative of an error rate for a signal received at a base station; adjust a signal quality target when the measured first value is determined to be outside a predefined range; measure a second value indicative of a signal quality for the signal received at the base station and comparing the measured signal to the adjusted signal quality target; examine whether the second value has reached or exceeded a threshold value; open a receiver diversity circuit in the base station when the second value reaches or exceeds the threshold value; measure again the second value indicative of the signal quality for the signal received at the base station and comparing the second value to the signal quality target; and send a signal to a mobile station instructing the mobile station to decrease output power used by the mobile station.

According to yet another aspect, a computer program product comprising instructions for execution by a processor is described. The executed instructions may measure a first value indicative of an error rate for a signal received at a mobile station; adjust a signal quality target in case the measured first value is determined to be outside of a predefined range; measure a second value indicative of the signal quality for the signal received at the mobile station and comparing the measured signal to the adjusted signal quality target; examine whether the second value has achieved or exceeded a threshold value; open a receiver diversity circuit in the mobile station when the second value achieves or exceeds the threshold value; measure again the second value indicative of the signal quality for the signal received at the mobile station and comparing the second value to the signal quality target; send a signal to a base station instructing the base station to decrease output power used by the base station.

### BRIEF DESCRIPTION OF THE DRAWINGS

FIG. 1 depicts a diversity receiver comprising a main antenna and a diversity antenna according to known technology.

FIG. 2 schematically depicts an exemplary base station according to one embodiment.

FIG. 3 illustrates an exemplary mobile station according.

FIG. 4 schematically illustrates uplink communication between two mobile stations and one base station.

FIG. 5 schematically illustrates downlink signaling between a base station and a mobile station according to one embodiment of the present invention.

FIG. 6 depicts a flow chart describing exemplary acts performed in a diversity receiver according to one embodiment.

### DETAILED DESCRIPTION OF PREFERRED EMBODIMENTS

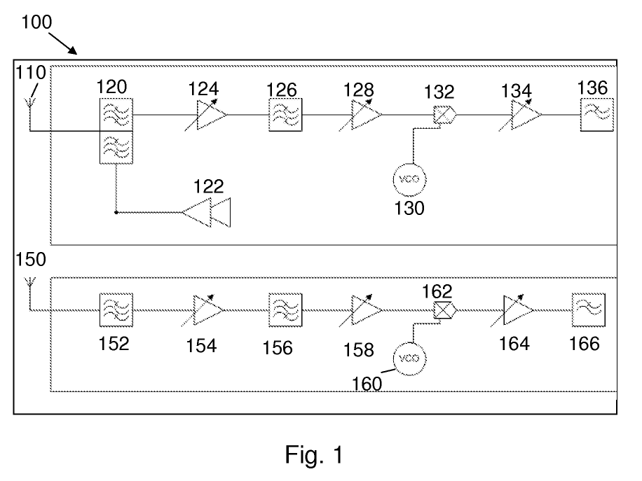

FIG. 1 illustrates a diversity receiver system 100 according to known technology.

The diversity receiver system 100 comprises a first or main antenna 110 and a second or diversity antenna 150. In some implementations, additional diversity antennas 150 may be used.

Usually, two different versions of the same signal are received at both the main antenna 110 and the diversity antenna 150. The signals have most probably traveled along different paths, experienced different attenuation and path loss along the different paths and hence will arrive at the main antenna 110 and the diversity antenna 150 with different SNR, RSSI or some other signal quality indicator.

After the first version of the signal has been received at the main antenna 110 the signal may be filtered in a duplexer filter 120 and then amplified by a low noise amplifier 124 in order to remove interference from other signals at frequencies near the signal frequency. The signal may also be amplified by a power amplifier 122.

Using the low noise amplifier 124, the interesting parts of the signal spectrum may be amplified and again frequency filtered by interstage filter 126. In the last part of the main receiver, the signal may be filtered down to an intermediate frequency by first being amplified by the variable amplifier 128 and mixed down to the low frequencies by mixer 132 by a predefined frequency produced by a VCO (Voltage Controlled Oscillator) 130 before being amplified again by the variable amplifier 134. Thereafter, the thus processed signal may be filtered by a low pass filter 136.

The diversity part of the diversity receiver comprising the diversity antenna 150 performs signal processing on the second version of the same signal in much the same way as in the case of the part of the receiver comprising the main antenna. Thus, the received second version of the signal is frequency filtered by filter 152 to filter out interference from other signals, amplified through variable amplifier 154 and filtered through interstage filter 156 in order to filter out undesired parts of the signal spectrum. Thereafter, the interesting parts of the signal spectrum are amplified by variable attenuator 158 before being mixed down to an intermediate frequency in mixer 162 by multiplying the signal with a predefined frequency produced by the VCO 160, whereafter the signal is amplified by the variable attenuator 164 and low pass-filtered in filter 166.

When using RX diversity the signals received at main antenna 110 and the diversity antenna 150 are frequently combined into one signal in order to improve the SNR of the signal by various means, such as EGC (Equal Gain Combining), MRC (Maximum Ratio Combining) or IRC (Interference Rejection Combining).

It should be mentioned that while a mobile station or a base station may use the RX diversity receiver in FIG. 1, the description of the RX diversity receiver is for illustration purposes only and should not be interpreted as limiting the mobile station or the base station according to only comprise such a RX diversity receiver.

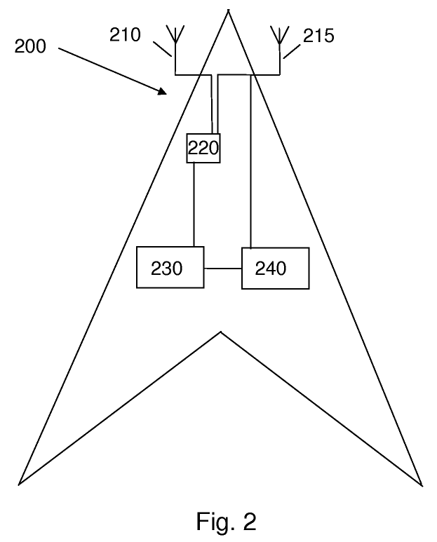

In FIG. 2, an exemplary embodiment of a base station 200 is shown. In this embodiment, base station 200 comprises a main antenna 210 and a diversity antenna 215. Main antenna 210 and diversity antenna 215 may have a structure similar to that described in FIG. 1. Both antennas 210, 215 are connected to a transceiver 220, which besides sending and receiving signals via main antenna 210 and diversity antenna 215, measures the BLER (Block Error Rate) for a signal received via either the main antenna 210, the diversity antenna 215, or both, depending on whether receiver diversity in the base station 200 is switched on or not. Also, the first unit measures the signal quality received at the base station 200 either as a SIR (Signal-to-Interference Ratio), a SINR (Signal-to-Interference-and-Noise Ratio), RSSI (Received Signal Strength Indicator) or some other parameter suitable for indicating the quality of the signal received at the base station 200.

The transceiver (220) may communicate with a processing unit 230 which compares the measured BLER value with a predefined BLER in order to decide whether the measured BLER is acceptable. Also, the processing unit 230 compares the measured value of the signal quality, such as a SIR value with a predefined SIR target. This predefined SIR target ensures that the signal transmitted from a mobile station to the base station 200 will fulfil the BLER requirement.

Also, processing unit 230 may compare the SIR value for a signal received at the base station 200 with a SIR value threshold. Here, the SIR threshold may be chosen as a SIR value where the current consumption due to switching on of the diversity antenna 215 would be lower than an additional increase of output power for a signal transmitted from a mobile station to the base station 200.

Base station 200 may also comprise a control unit 240 which, depending on whether the measured SIR value is greater than the SIR threshold value, switches on the diversity antenna 215 in order to lower the SIR needed to meet the SIR target. The switching on of the diversity antenna 215 by the control unit 240 may be performed by sending control signals to a solid state switch (not shown) which would open the diversity antenna 215.

In case the measured SIR value is lower than the SIR threshold value, the mobile station from which the signal was received is instructed to increase its output power in order to meet the SIR target.

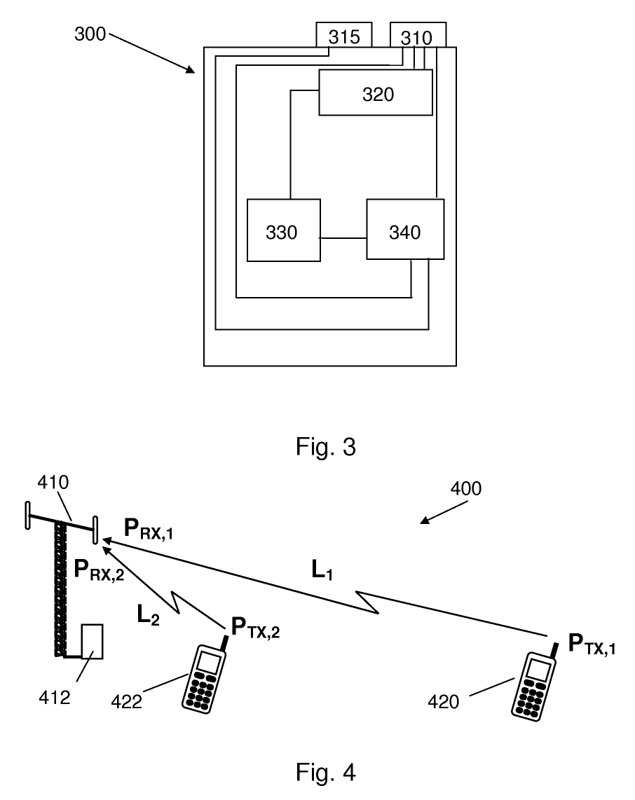

FIG. 3 illustrates an exemplary mobile station 300 according to one embodiment. Mobile station 300 comprises a main antenna 310 and a diversity antenna 315. Main antenna 310 and diversity antenna 315 may fulfil essentially the same function as their counterparts in the base station in FIG. 2. A transceiver 320, analogously to the transceiver 220 in FIG. 2, may determine the BLER of a signal received at the mobile station 300 and a signal quality value, such as SIR, SINR, RSSI (Received Signal Strength Indicator) or some other value indicative of the signal quality received. The remaining units in the mobile station 300, i.e. the processing unit 330 and the control unit 340, perform identical operations as their counterparts in the base station 200 in FIG. 2. For this reason, a detailed description of these components will not be repeated here. A difference between mobile station 300 and base station 200 is that the direction of communication is reversed with respect to the case in FIG. 2, where the base station 200 receives a signal from a mobile station, such as, for example the mobile station 300.

Turning now to FIG. 4, an example wireless communication system 400 is shown comprising a base station 410 with a control unit 412, a first mobile station 420 and a second mobile station 422, where the first mobile station 420 communicates with the base station 410 on a first radio link experiencing a first uplink loss L1, and the second mobile station 422 on a second link experiences a second uplink loss L2.

Both mobile stations 420 and 422 may send their signals with a first and a second transmit power P_{TX,1} and P_{TX,2} to the base station 410. These transmit powers may or may not be equal depending on the proximity of the mobile stations 420, 422 to the base station and possibly some other factors. Now, on the path to the base station, the signals transmitted with the transmit powers P_{TX,1} and P_{TX,2} may experience different attenuation, interference and path loss. This will have an effect on the signal power received at the base station 410, which in this example is depicted as the first received signal power P_{RX,1} for the signal received from the first mobile station 420 and the second received signal power P_{RX,1} for the signal received from the second mobile station 422. However, not only will the signals transmitted by the first and second mobile stations 420 and 422 experience attenuation, interference and path loss, but each signal may be reflected and transported along different paths to the base station 410, which may lead to the same signal appearing in different “versions” at the base station.

Using RX diversity however, these different “versions” of the same signal may be combined in a RX diversity receiver, such as, for example, the receiver from FIG. 1, in a base station in order to improve the SNR of the received signal. This may, for example, be done by the base station by first determining the signal powers P_{TX,1} and P_{TX,2} from the signals transmitted from the first and second mobile stations 420 and 422 and thereafter determining the uplink path loss L1 and L2 for these signals.

Assuming that the uplink path loss is equal to the downlink path loss it may be possible for the base station 410 to determine the transmitted signal powers P_{TX,1} and P_{TX,2} from the uplink path losses L1 and L2 and hence to compensate for the distance of the first and second mobile stations 420 and 422 to the mobile stations plus the shadowing of the two signals. Shadowing of a signal arises from obstacles in the way of the signal when it travels from the mobile station to the base station.

The base station may then send a control message (not shown) produced by the control unit 412 to the first and second mobile stations 420, 422 to decrease or increase the power P_{TX,1}, P_{TX,2} for their transmitted signals in order to achieve the goal of receiving these two signals at roughly equal power P_{RX,1} and P_{RX,2}. The reason for wanting to receive the two signals at roughly equal powers may, for example, be coupled to a desired SIR (Signal-to-Interference Ratio) threshold. The base station 410 may achieve this goal either by sending a control message (not shown) to mobile stations farther away from it, in this case the first mobile station 420, to send it's signal with higher transmit power P_{TX,1} or by switching on its diversity antenna.

When it is desired to reduce current consumption in the mobile stations 420, 422, the base station 410 may make use of receiver diversity by switching on a second receiver antenna, thus avoiding making the mobile stations 420, 422 sending their signals with higher power and using bandwidth for control messages to the mobile stations 420, 422 on the downlink channel. It may also be added that when the received signal power P_{RX,1} and P_{RX,2} is sufficient to meet the SIR target, the mobile stations 420 and 422 will be able to transit their signals at lower transmit powers P_{TX,1} and P_{TX,2} and thus reduce their power consumption.

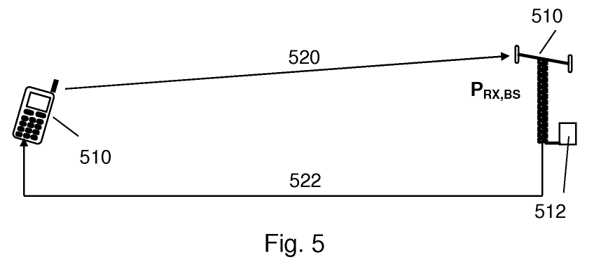

However, in some situations, it may be desired to use a goal of current consumption reduction to save power in the base station 410 (taking into account that the mobile stations will have their own power saving mechanisms). In this situation, the benefits of receiver diversity (higher SIR) may be weighed against making the mobile stations 420, 422 transmit at higher power P_{TX,1}, P_{TX,2}. This will be explained in more detail with reference to FIG. 5.

FIG. 5 illustrates exemplary control signaling between a base station 510 and a mobile station 510 in the situation in which it is desired to reduce current consumption at the base station 510.

Having received a signal from a mobile station 510 on the uplink 520 with a received power P_{RX, BS} the control unit 512 in the base station calculates the actual SIR taking into account the received power P_{RX,BS} and the attenuation on the downlink. After comparison with a target SIR, the base station 510 may decide whether to send a control message 522 to the mobile station 510 to make it increase it's transmit power or whether to switch on its diversity antenna. When the primary goal is to reduce current consumption of the base station 510, the base station will wait with the switching on of its diversity antenna and send a control message 522 to the mobile station to make it increase its transmit power. This may either be done once after an estimation of the necessary transmit power which would meet the SIR target at the base station 510 or be performed continuously until the SIR target is met.

Estimating the necessary transmit power for the mobile station 510 and sending one or a few control messages to the mobile station 510 may have the advantage of decreasing the load on the downlink, i.e. the air interface between the base station 510 down to the mobile station 510. However, the advantage of adaptive transmit power control would be to better be able to react to changing transmission conditions on the uplink.

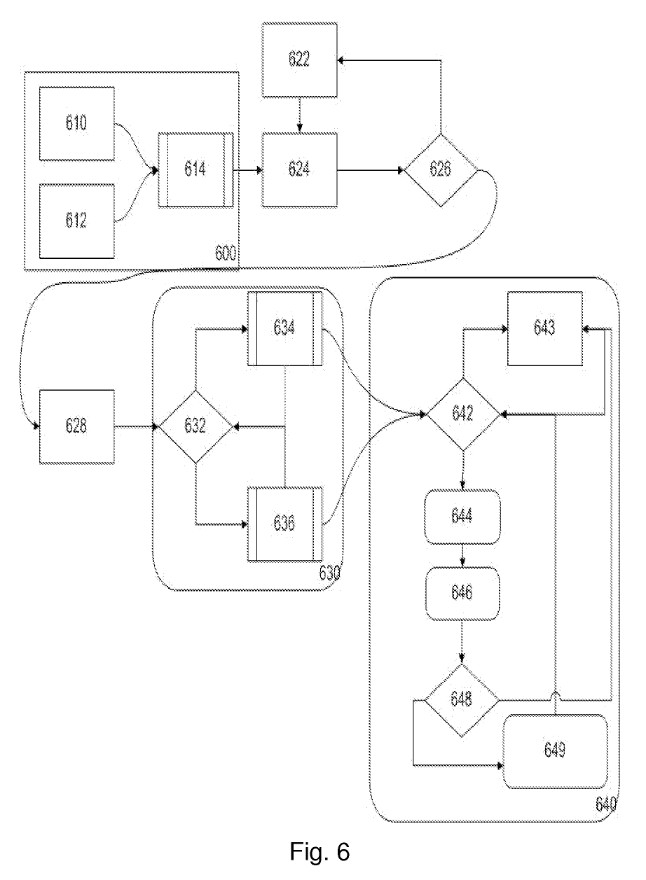

Next, an exemplary method according to an embodiment is presented with respect to the flow chart of FIG. 6.

Outer loop power control processing 600 (acts 610, 612 and 614) will be initially explained. At acts 610 and 612, one or more mobile stations 420 (act 610), 422 (act 612) may measure the power of a signal received from the base station 410 at their receivers and at the same time read the transmit power from the base station 410 on the broadcast channel. These two parameters may be combined by the one or more mobile stations (act 614) in order to calculate a suitable transmit power for a signal with which the one or more mobile stations 420, 422 intend to transmit to the base station 410.

The one or more mobile stations 420, 422 may transmit a transmit access preamble to the base station 410 in order to get permission to send their data (act 624). If the base station 410 has acknowledged the transmit access with the one or more mobile station 420, 422 (act 626), the one or more mobile stations 420, 422 may proceed with sending their data (act 628).

However, if such an acknowledgment was not received by the one or more mobile stations 420, 422, the mobile stations may increase their transmit power by a certain amount, such as by, for example, 1 dB or more (acts 626 and 622). Thereafter, they again may attempt to transmit the access preamble (act 624) to the base station 410.

After a successful access grant by the base station 410, at act 628, the one or more mobile stations may examine, at act 632, if the BLER (Block Error Rate) for the transmitted signal is acceptable. In this context, acceptable may mean a BLER which is approximately 10⁻⁵ or lower. In case the BLER is unacceptable for transmitting a signal which will be fully recoverable by the base station 410, the one or more mobile stations 420, 422 may increase the SIR target in order to be able to reach the predefined BLER target (acts 632 and 634). The information about the BLER for the one or more mobile stations 420, 422 may either be obtained statistically by taking CQI (Channel Quality Indicator) measurements from the base station 410 into account or by some other appropriate means. Information about the increased SIR target may then for example be transmitted in a control message to the base station 410 (acts 632 and 636).

Thereafter, at act 642, it may be checked at the base station whether the received target SIR is higher than the existing SIR target in base station 410 (act 642). If this is not the case, then the base station 410 may instruct the one or more mobile stations 420, 422 to decrease the transmitted signal power (act 643). Thus, the mobile stations will not transmit their signals with unnecessary high output power and therefore reduce current consumption. Thereafter, the one base station 410 may check again (act 642) whether the received SIR is higher than the target SIR.

If this is the case, the base station may check whether the SIR target received from the one or more mobile stations 420, 422 is greater than a predefined threshold value for the SIR. It may be mentioned here that the SIR threshold value may be set so that above the threshold the current consumption due to increased transmitted power from the one or more mobile stations 420, 422 would be greater than the current consumption in the base station 410 due to switched on receiver diversity. Now, if at act 642 the SIR target as received from the mobile stations 420, 422 is higher than the existing SIR threshold, the base station 410 may switch on its diversity antenna (act 644) in order to lower the value necessary for the SIR in a signal received from one or more of the mobile stations 420, 422, and therefore may save current in mobile station due to there not being a need to increase output power.

At act 646 base station 410 may again measure the SIR of the signals or signals received from the one or more mobile station 420, 422. At act 648 the base station 410 may check whether the SIR for the signals received from the one or more mobile stations 400, 422 is lower than the newly set SIR target. If this is the case, the base station 210 may instruct the one or more mobile stations 420, 422 (act 643) to decrease the signal transmit power and returns to act 642 in order to determine whether the newly received SIR is greater than the SIR target.

However, if the SIR for the signal or signals received from the one or more mobile stations is higher than the SIR target value (act 648), then the switching on of the diversity circuit 100 in the base station 410 was not enough to achieve the desired BLER and therefore, the base station may force (act 649) the one or more mobile stations to increase the signal transmitted power in order to achieve the desired SIR and hence the desired BLER.

It may be appreciated here that the exemplary method described in FIG. 6 may be used in any kind of wireless communication network, such as a GSM network, a GPRS network, an EDGE network, a 3G mobile network (UMTS, CDMA2000), a WLAN (Wireless Local Area network) such as for instance IEEE 802.11, 802.15, or 802.16 based networks, PLAN (Personal Local Area network), piconet networks, and all other types of networks where there is an access point or gateway and at least one mobile station communicating with the access point.

It may also be added that, while the example method according has been described on the uplink, i.e. when the one or more mobile stations transmit data to the base station, the method may also be used on the downlink, i.e., when it is the base station that is transmitting data to the one or more mobile stations. In this case, the outer loop power control 630 may be executed by the base station, while the inner loop power control 640 will be executed by the one or more mobile stations 420, 422.

What is claimed:

1. A method of reducing power consumption in a base station in a wireless communication network, the method comprising:
measuring a first value indicative of an error rate for a signal received at the base station;
adjusting a signal quality target when the measured first value is determined to be outside a predefined range;
measuring a second value indicative of a signal quality for the signal received at the base station and comparing the measured signal to the adjusted signal quality target;
examining whether the second value has reached or exceeded a threshold value;
opening a receiver diversity circuit in the base station when the second value reaches or exceeds the threshold value;
measuring again the second value indicative of the signal quality for the signal received at the base station and comparing the second value to the signal quality target; and
sending a signal to a mobile station instructing the mobile station to decrease output power used by the mobile station.

2. The method according to claim 1, wherein the method is performed at predefined time periods.

3. The method according to claim 1, wherein the first value indicative of the error rate is at least one of BLER (Block Error Rate), FER (Frame Error Rate), or BER (Bit Error Rate.

4. The method according to claim 1, wherein the signal quality target and the second value indicative of the signal quality is at least one of SIR (Signal to Interference Ratio), SINR (Signal-to-Interference-and-Noise Ratio), or RSSI (Received Signal Strength Indicator).

5. The method according to claim 1, wherein the threshold value for the signal quality of the signal received at the base station comprises a value in which increased output power in the signal received at the base station leads to a greater power consumption in the mobile station than the power consumption in the base station due to opening the receiver diversity circuit in the base station.

6. The method according to claim 1, wherein the output power for the signal received at the base station is the power at which the signal was transmitted from one or more mobile stations in the wireless communication network.

7. A method of reducing power consumption in a mobile station in a wireless communication network, the method comprising:
measuring a first value indicative of an error rate for a signal received at the mobile station;
adjusting a signal quality target in case the measured first value is determined to be outside of a predefined range;
measuring a second value indicative of the signal quality for the signal received at the mobile station and comparing the measured signal to the adjusted signal quality target;
examining whether the second value has achieved or exceeded a threshold value;
opening a receiver diversity circuit in the mobile station when the second value achieves or exceeds the threshold value;
measuring again the second value indicative of the signal quality for the signal received at the mobile station and comparing the second value to the signal quality target; and
sending a signal to a base station instructing the base station to decrease output power used by the base station.

8. The method according to claim 7, wherein the output power for the signal received at the base station is the power at which the signal was transmitted from one or more base stations in the wireless communication network.

9. A mobile station for communication in a wireless communication network comprising:
a first unit for measuring a first value indicative of an error rate for a signal received at the mobile station and for measuring a second value indicative of a signal quality for the signal received at the mobile station;
a second unit for comparing the measured first value with a predefined value indicative of the error rate for the signal and for comparing the second value with a threshold value indicative of the signal quality;
a diversity receiver circuit; and
a control unit for adjusting a signal quality target when the measured first value is determined to be outside a predefined range, where the control unit is further configured to open the receiver diversity circuit when the threshold value indicative of the signal quality has been reached or exceeded,
wherein the first unit is further configured to repeatedly measure the second value indicative of the signal quality for the signal received at the mobile station and where the second unit is further configured to repeatedly compare the second value indicative of the signal quality for the signal received at the mobile station with the target signal quality and wherein the control unit is configured to send a signal to a base station instructing the base station to decrease output power sent to the mobile station.

10. A mobile station according to claim 9, wherein the first unit comprises a transceiver and where the second unit comprises a processing unit.

11. A base station for communication in a wireless communication network comprising:
a first unit for measuring a first value indicative of an error rate for a signal received at the base station and for measuring a second value indicative of a signal quality for the signal received at the base station;
a second unit for comparing the measured first value with a predefined value indicative of the error rate for the signal and for comparing the second value with a threshold value indicative of the signal quality;
a diversity receiver circuit; and
a control unit for adjusting a signal quality target when the measured first value is determined to be outside a predefined value range, where the control unit is further configured to open the receiver diversity circuit when the threshold value indicative of the signal quality has been reached or exceeded,
wherein the first unit is further configured to repeatedly measure the second value indicative of the signal quality for the signal received at the base station and where the second unit is further configured to repeatedly compare the second value indicative of the signal quality for the signal received at the base station with the target signal quality and wherein the control unit is configured to send a signal to a mobile station instructing the mobile station to decrease output power sent to the base station.

12. A base station according to claim 11, wherein the first unit comprises a transceiver and the second unit a processing unit.

13. A computer program product comprising instructions for execution by a processor to:
measure a first value indicative of an error rate for a signal received at a base station;
adjust a signal quality target when the measured first value is determined to be outside a predefined range;
measure a second value indicative of a signal quality for the signal received at the base station and comparing the measured signal to the adjusted signal quality target;
examine whether the second value has reached or exceeded a threshold value;
open a receiver diversity circuit in the base station when the second value reaches or exceeds the threshold value;
measure again the second value indicative of the signal quality for the signal received at the base station and comparing the second value to the signal quality target; and
send a signal to a mobile station instructing the mobile station to decrease output power used by the mobile station.

14. A computer program product comprising instructions for execution by a processor to:
measure a first value indicative of an error rate for a signal received at a mobile station;
adjust a signal quality target in case the measured first value is determined to be outside of a predefined range;
measure a second value indicative of the signal quality for the signal received at the mobile station and comparing the measured signal to the adjusted signal quality target;
examine whether the second value has achieved or exceeded a threshold value;
open a receiver diversity circuit in the mobile station when the second value achieves or exceeds the threshold value;
measure again the second value indicative of the signal quality for the signal received at the mobile station and comparing the second value to the signal quality target; and
send a signal to a base station instructing the base station to decrease output power used by the base station.
